(19) United States
(12) Patent Application Publication
(10) Pub. No.: US 2026/0029969 A1
(43) Pub. Date: Jan. 29, 2026

(54) INFORMATION PROCESSING APPARATUS, AND INFORMATION PROCESSING METHOD

(71) Applicant: CANON KABUSHIKI KAISHA, Tokyo (JP)

(72) Inventor: JUNICHI SUWA, Chiba (JP)

(21) Appl. No.: 19/270,823

(22) Filed: Jul. 16, 2025

(30) Foreign Application Priority Data
Jul. 26, 2024 (JP) 2024-121303

(51) Int. Cl. G06F 3/12

(52) U.S. Cl. CPC G06F 3/121; G06F 3/1273

(57) ABSTRACT

An information processing apparatus includes a first obtaining unit configured to obtain information on an item selected by a user from items each specifying a problem tending to occur in execution of a print job; a second obtaining unit configured to obtain setting information of a print job selected by the user from print jobs which were executed by an image forming apparatus and which were extracted as candidates for a job in which the problem specified by the selected item occurred; and a display control unit configured to display a screen which contains a solution for the problem based on the information obtained by the first obtaining unit and contains the setting information of the print job obtained by the second obtaining unit.

### BACKGROUND

### Field of the Technology

The present disclosure relates to processing of diagnosing a problem in an image forming apparatus.

### Description of the Related Art

In a case where a multi-function printer (MFP) executes a job, a problem may occur, such as an error end or a failure to obtain an expected output even though the job ends normally. In order to resolve the problem, a user may need to make an inquiry to a call center or have service personnel dispatched. In order to reduce the number of inquiries to the call center or dispatches of service personnel, there is a demand to provide a function that enables users to resolve the problem by themselves.

Japanese Patent Laid-Open No. 2020-087136 discloses that solutions to help users resolve the problem by themselves are displayed.

### SUMMARY

An information processing apparatus in the present disclosure includes a first obtaining unit configured to obtain information on an item selected by a user from items each specifying a problem tending to occur in execution of a print job; a second obtaining unit configured to obtain setting information of a print job selected by the user from print jobs which were executed by an image forming apparatus and which were extracted as candidates for a job in which the problem specified by the selected item occurred; and a display control unit configured to display a screen which contains a solution for the problem based on the information obtained by the first obtaining unit and contains the setting information of the print job obtained by the second obtaining unit.

Features of the present disclosure will become apparent from the following description of embodiments with reference to the attached drawings. The following description of embodiments are described by way of example.

### BRIEF DESCRIPTION OF THE DRAWINGS

FIG. 1 is a block diagram illustrating an example of a hardware configuration of an image forming apparatus;

FIG. 2 is a diagram illustrating an example of a functional configuration of the image forming apparatus;

FIG. 3 is a flowchart for explaining print processing;

FIG. 4 is a diagram illustrating an example of job logs;

FIG. 5 is a flowchart for explaining an outline of problem diagnosis processing;

FIG. 6 is a diagram illustrating an example of a menu screen of a problem diagnosis;

FIG. 7 is a diagram illustrating an example of a problem candidate job display screen;

FIG. 8 is a flowchart for explaining problem candidate job display processing;

FIG. 9 is a diagram presenting an example of a candidate job extraction table;

FIG. 10 is a flowchart for explaining possible solution display processing;

FIG. 11 is a diagram showing the relationship of FIGS. 11A and 11B;

FIGS. 11A and 11B are diagrams presenting an example of a solution list;

FIG. 12 is a diagram illustrating an example of a possible solution display screen;

FIG. 13 is a flowchart for explaining possible solution display processing;

FIG. 14 is a diagram illustrating an example of a possible solution display screen;

FIG. 15 is a flowchart for explaining possible solution display processing; and

FIG. 16 is a diagram illustrating an example of a possible solution display screen.

### DESCRIPTION OF THE EMBODIMENTS

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

### First Embodiment

In the present embodiment, description will be given of an example of an image forming apparatus configured to display a solution to a problem and setting information of a job on a screen.

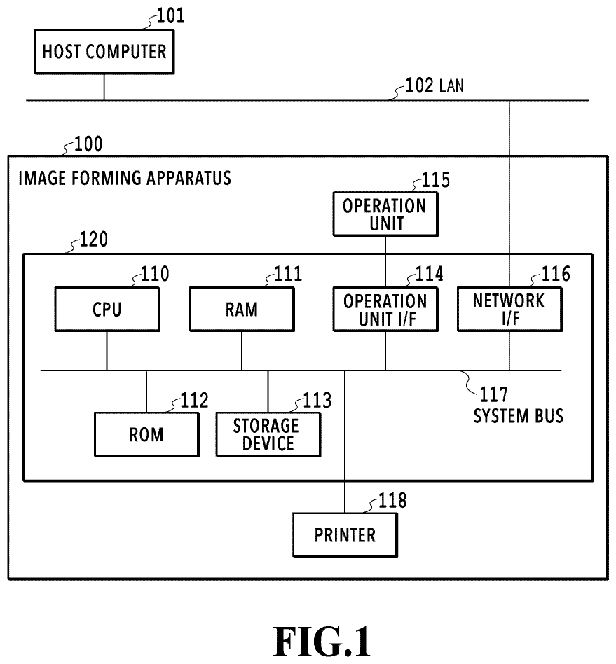

FIG. 1 is a diagram illustrating a configuration example of a printing system in the present embodiment. The printing system includes a host computer 101 and an image forming apparatus 100. The host computer 101 and the image forming apparatus 100 are connected to each other via a LAN 102. A user creates print data on the host computer 101, and transmits the print data from the host computer 101 to the image forming apparatus 100 via the LAN 102. In the present embodiment, the image forming apparatus 100 may be either a multi-function printer (MFP) or a single-function printer (SFP). The MFP is a printer having multiple functions such as fax, copy, print, and scan functions. The SFP is a printer having a print function only.

### Hardware Configuration of Image Forming Apparatus

Using FIG. 1, a configuration example of the image forming apparatus 100 in the present embodiment will be described. The image forming apparatus 100 includes an operation unit 115, a printer 118, and a controller unit 120 (information processing apparatus). In other words, the image forming apparatus 100 is equipped with a built-in information processing apparatus as the controller unit 120.

The printer 118 is a print engine to perform printing on a print medium (such as paper) according to PDL data interpreted by a CPU 110 of the controller unit 120. The operation unit 115 has functions as a display unit to display various menus, information about print data requested to be printed, and the like, and an input unit to receive inputs by the user. The operation unit 115 includes, for example, a display unit having a touch panel function, physical buttons, and so on. The operation unit 115 and the printer 118 are connected to the controller unit 120, and execute functions as the image forming apparatus 100 according to control by the controller unit 120.

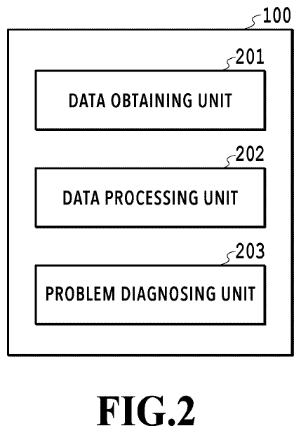

A hardware configuration of the controller unit 120 will be described. The CPU 110 is the center of a control unit of the image forming apparatus 100, the control unit configured to comprehensively control devices connected to a system bus 117. A RAM 111 is a memory device accessible by the CPU 110 and is used as a work memory for the CPU 110 to perform operations. A ROM 112 is a memory device that stores programs. The CPU 110 loads a program stored in the ROM 112 onto the RAM 111 and executes the program to operate functional units presented in FIG. 2, which will be described later. A storage device 113 is, for example, a hard disk drive, and stores system software for various kinds of processing, print data received by the image forming apparatus 100, and so on.

An operation unit I/F 114 is an interface unit for the operation unit 115. The operation unit I/F 114 outputs operation screen data to the operation unit 115 and inputs, to the CPU 110, information input by the user via the operation unit 115. The CPU 110 operates as an operation control unit and a display control unit for controlling screens displayed on a touch panel display serving as the display unit of the operation unit 115.

A network I/F 116 is an interface for exchange information with an external apparatus such as the host computer 101 via the LAN 102. In the present embodiment, page description language (PDL) data is received as print data from the external apparatus.

### Functional Configuration of Image Forming Apparatus

FIG. 2 is a diagram illustrating an example of a functional configuration of the image forming apparatus 100. The image forming apparatus 100 includes a data obtaining unit 201, a data processing unit 202, and a problem diagnosing unit 203. The CPU 110 executes the program loaded from the ROM 112 to the RAM 111, thereby implementing the functional units in FIG. 2.

The data obtaining unit 201 receives PDL data.

The data processing unit 202 interprets the received PDL data and executes print processing. The data processing unit 202 records information about the PDL data and a print result as a job log.

The problem diagnosing unit 203 narrows down possible solutions to a problem based on the problem information and the job log, and displays the possible solutions on the touch panel display of the operation unit 115. The problem diagnosing unit 203 displays details of a selected possible solution on the operation unit 115.

### Flowchart

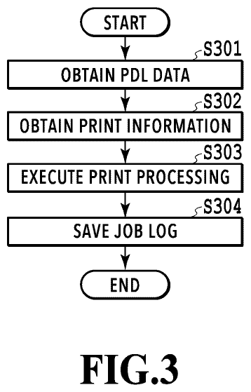

FIG. 3 is a flowchart presenting a sequence of processing including obtaining PDL data, executing print processing, and storing a job log. A series of processes executed in the flowchart of FIG. 3 is performed by the CPU 110 of the controller unit 120 expanding program codes stored in the ROM 112 onto the RAM 111 and executing the program codes. Instead, some or all of steps in the flowchart of FIG. 3 may be implemented by hardware such as an ASIC or electronic circuit. Sign “S” described in each process in the flowchart described below means a step, and the same applies to the other following flowcharts.

In S301, the data obtaining unit 201 receives PDL data via the network I/F 116. Specifically, the data obtaining unit 201 receives a print job containing a print instruction from the host computer 101 on which the PDL data is created, thereby receiving the PDL data. Instead, the data obtaining unit 201 may obtain the PDL data pooled in the storage device 113 of the image forming apparatus 100.

In S302, the data obtaining unit 201 obtains print information. The print information is information related to the obtained PDL data, and contains information necessary to perform print processing on the PDL data or information to be recorded in the job log.

The print information is, for example, information on the OS, the driver, and the application used to create the PDL data, driver setting information, and main unit setting information which is stored in the storage device 113 of the image forming apparatus 100. The driver setting information is information on a paper size, a paper type, a page layout, and so on. The main unit setting information is information on halftone, thickness adjustment, and so on.

As a method of obtaining the print information, for example, there is a method of obtaining print settings attached to the PDL data by analyzing the PDL data or a method of obtaining print settings stored in the storage device 113 of the image forming apparatus 100. As a method of obtaining the information on the OS, the driver, and the application used to create the PDL data, there is a method of obtaining the information from the PDL data to which the information is attached or a method of obtaining the information via the network I/F 116 separately from the PDL data.

In S303, the data processing unit 202 executes the print processing. In the print processing, the data processing unit 202 analyzes the obtained PDL data and generates interim data for the number of pages. Next, the data processing unit 202 executes raster image processor (RIP) processing based on the generated interim data, thereby performing image formation processing to generate an image in the raster format. After that, the data processing unit 202 executes image processing on the image in the raster format. The printer 118 prints, on a print medium, the image in the raster format after the image processing.

In S304, the data processing unit 202 executes job-log saving processing. In the job-log saving processing, the data processing unit 202 executes processing of recording, in the storage device 113 as a job log, the information related to the PDL data or the like on which the print processing was executed. The data processing unit 202 builds a job log database (DB) in the storage device 113, and saves the generated job log together with past job logs in the job log DB.

### Job Log

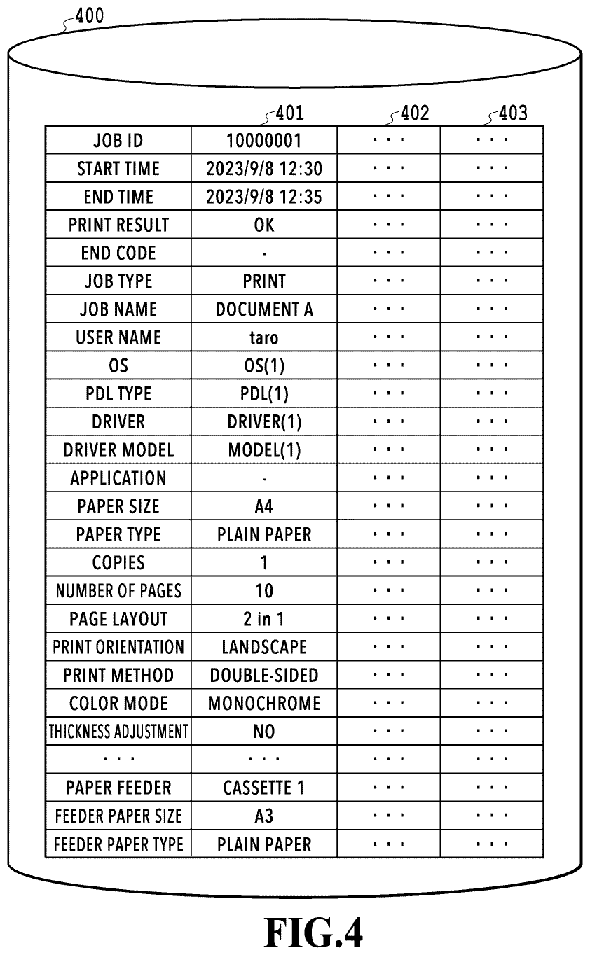

FIG. 4 is a diagram illustrating an example of the job log DB and job logs. In FIG. 4, each of job logs 401 to 403 contained in a job log DB 400 is information on an executed job. The job log contains information obtained before the print processing, a result of the printing, and so on. For example, from the above print information, the information on the OS, the driver, and the application used to create the PDL data and the driver setting information are stored as a job log. The CPU 110 also functions as a job log management unit to manage job logs.

The job log is managed for each job ID, which is a unique value identifying an executed job. The job log contains values of various items. An example of items contained in a job log is as follows.
“START TIME” specifies a start time of the print processing.
“END TIME” specifies an end time of the print processing.
“PRINT RESULT” is a value indicating a job processing result. A value for a normal end is OK and a value for an abnormal end is Not OK.
“END CODE” is an indentation number for checking an error message in the case where the print result is Not OK. In the case where the print result is OK, “-” is stored as the job log.
“JOB TYPE” specifies a job type such as fax, copy, print, or scan.
“JOB NAME” specifies the name of a printed file.
“USER NAME” specifies the name of a user who executed the job.
“OS” specifies the name of an operating system (OS) of a terminal on which the user instructed the execution of the job. For example, OS(1), OS(2), or the like is stored as the job log.
“PDL TYPE” specifies a type of PDL data. For example, PDL(1), PDL(2), or the like is stored as the job log.
“DRIVER” specifies the name of a printer driver used in the printing. In the case of a job in which a driver was not used due to direct printing or the like, “-” is stored as the job log.
“DRIVER MODEL” specifies a model applied to the driver used in the printing.
“APPLICATION” specifies the name of an application that instructed the print execution.
“PAPER SIZE” specifies the size of paper set in the printer driver and actually used in the printing. A4, B4, post card, or the like is stored as the job log.
“PAPER TYPE” specifies a type of paper set in the printer driver and actually used in the printing. Plain paper, thick paper, envelope, or the like is stored as the job log.
“COPIES” specifies the number indicating how many print products with the same contents were printed.
“NUMBER OF PAGES” specifies the number of pages in the PDL data.
“PAGE LAYOUT” specifies a value specifying a setting of combine printing or the like.
“PRINT ORIENTATION” specifies a value indicating a portrait or landscape setting.
“PRINT METHOD” specifies a value indicating a single-sided or double-sided print setting.
“COLOR MODE” specifies a value indicating a color, monochrome, or automatic color setting.
“THICKNESS ADJUSTMENT” specifies a value indicating whether or not to thicken characters, lines, graphics, or the like.
“PAPER FEEDER” specifies a value indicating a paper feeder set in the printer driver.
“FEEDER PAPER SIZE” specifies a value indicating a paper size of the paper feeder set in the printer driver.
“FEEDER PAPER TYPE” specifies a value indicating a paper type of the paper feeder set in the printer driver.

The items recorded as the job logs in FIG. 4 are just an example, and items to be recorded are not limited to the items presented in FIG. 4. In the job log DB 400, job logs of respective jobs are cumulatively stored and are used for display of the job history, a diagnosis of a print problem, or the like.

### Problem Diagnosis Processing

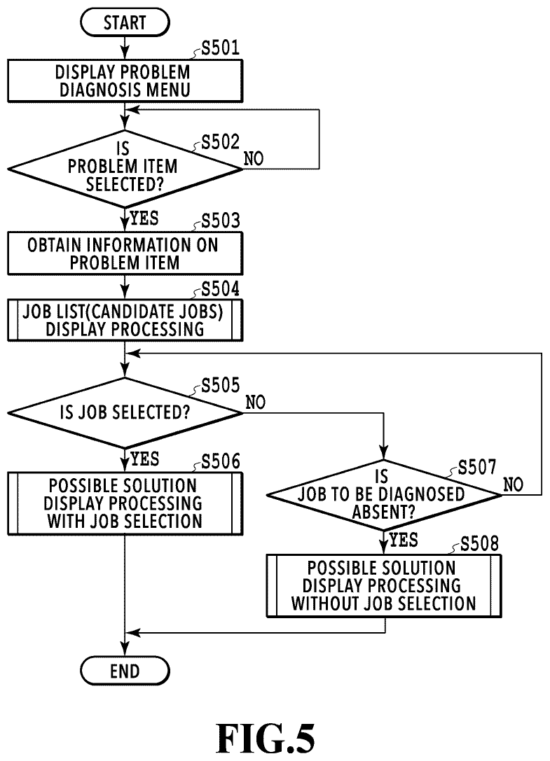

FIG. 5 is a flowchart presenting an outline of print problem diagnosis processing. A series of processes executed in the flowchart of FIG. 5 is performed by the CPU 110 of the controller unit 120 expanding program codes stored in the ROM 112 onto the RAM 111 and executing the program codes. Instead, some or all of steps in the flowchart of FIG. 5 may be implemented by hardware such as an ASIC or electronic circuit.

The problem diagnosis is processing of determining candidates for a solution to resolve a problem (referred to as possible solutions) and presenting them to the user. For this reason, the problem diagnosis makes it possible for the user to resolve the problem by themselves. The flowchart in FIG. 5 is started in response to an action in which the user depresses a predetermined button on a home screen (not illustrated) displayed on the touch panel display of the operation unit 115. A job in which a problem occurred is defined as a job in which a malfunction occurred, and includes not only a job that ended with an error and has a Not OK job result, but also a job that ended normally but failed to produce an expected result.

In S501, the problem diagnosing unit 203 causes the touch panel display of the operation unit 115 to display a menu screen for diagnosing a job in which a problem occurred.

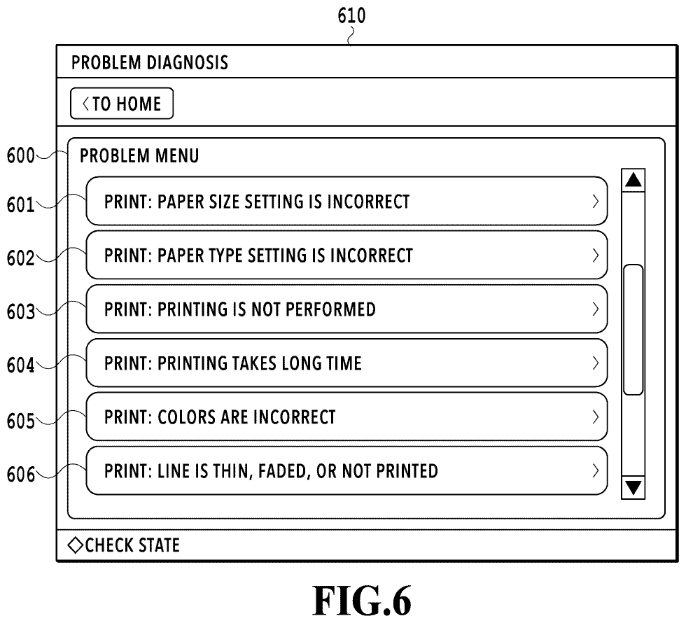

FIG. 6 is a diagram illustrating an example of a menu screen of the problem diagnosis. A menu screen 610 includes a problem item display area 600. The problem item display area 600 includes menu buttons 601 to 606 for respective problem items each specifying one of symptoms of malfunctions of the functions. The user depresses the button associated with a problem desired to be diagnosed from among the buttons included in the problem item display area 600. For example, in the case where the user desires to diagnose why the problem in which paper size setting is incorrect occurred in printing, the user depresses the menu button 601 on which the problem item specifying the above the problem is displayed.

In S502, the problem diagnosing unit 203 determines whether or not a problem item is selected in response to an action of depressing any of the menu buttons included in the problem item display area 600 presented in FIG. 6.

If determining that the problem item is selected (YES in S502), the problem diagnosing unit 203 advances the processing to S503. If determining that the problem item is not selected (NO in S502), the problem diagnosing unit 203 waits until a problem item is selected.

In S503, the problem diagnosing unit 203 obtains information on the selected problem item.

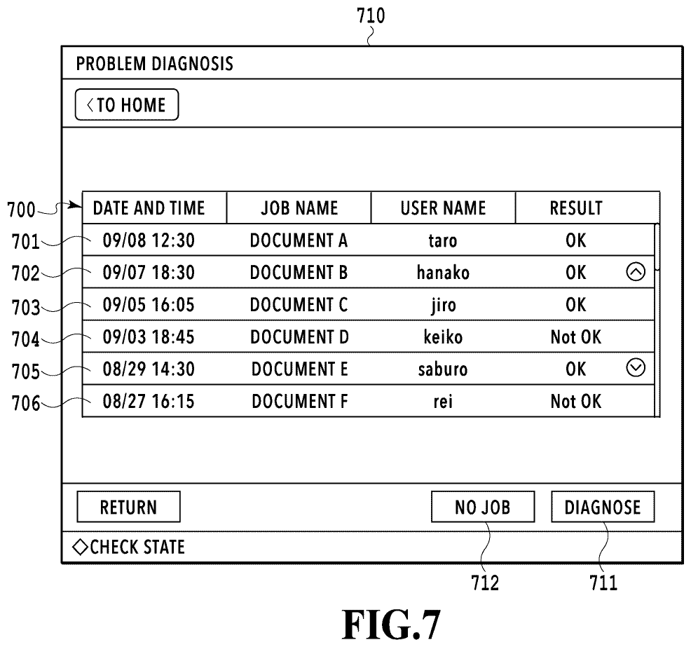

In S504, the problem diagnosing unit 203 generates a list of candidates for a job in which the problem specified by the selected problem item occurred, based on the information on the selected problem item. This job list will be referred to as a problem candidate job list. Then, the problem diagnosing unit 203 displays a screen including the generated problem candidate job list 700 (see FIG. 7) on the touch panel display of the operation unit 115.

FIG. 7 is a diagram illustrating a problem candidate job display screen 710 which is displayed on the operation unit 115 and includes the problem candidate job list 700. The problem candidate job list 700 included in the problem candidate job display screen 710 in FIG. 7 is a list composed of information on jobs considered to have the problem associated with the button selected from the problem item display area 600 in FIG. 6. The problem candidate job list 700 includes job information display regions 701 to 706. In each of the job information display regions 701 to 706, date and time, job name, user name, result, and so on are displayed as job information. The processing in S504 will be described in detail later.

In S505, the problem diagnosing unit 203 determines whether or not a job to be diagnosed is selected from the problem candidate job list 700. In the case where the user selects a job to be diagnosed from the job information display regions 701 to 706 in FIG. 7 and depresses a diagnosis button 711, the problem diagnosing unit 203 determines that the job to be diagnosed is selected. If determining that the job to be diagnosed is selected (YES in S505), the problem diagnosing unit 203 advances the processing to S506.

In S506, the problem diagnosing unit 203 performs processing of diagnosing the information on the selected job to be diagnosed, and displaying proper possible solutions. The details of the processing will be described later.

If determining that the job to be diagnosed is not selected (NO in S505), the problem diagnosing unit 203 advances the processing to S507. In S507, the problem diagnosing unit 203 determines whether or not the absence of a job to be diagnosed is selected. In the case where a NO JOB button 712 in FIG. 7 is depressed, the problem diagnosing unit 203 determines that the absence of a job to be diagnosed is selected. If determining that the absence of a job to be diagnosed is selected (YES in S507), the problem diagnosing unit 203 advances the processing to S508.

In S508, the problem diagnosing unit 203 preforms solution display processing for a case where there is no job desired to be diagnosed. The details of the processing will be described later.

On the other hand, in the case where the NO JOB button 712 in FIG. 7 is not depressed (NO in S507), the processing returns to S505.

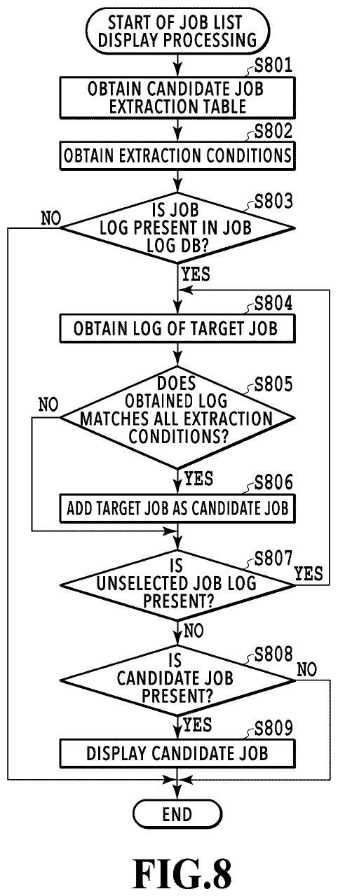

FIG. 8 is a flowchart for explaining the details of the processing of displaying the problem candidate job list 700 in S504 of FIG. 5.

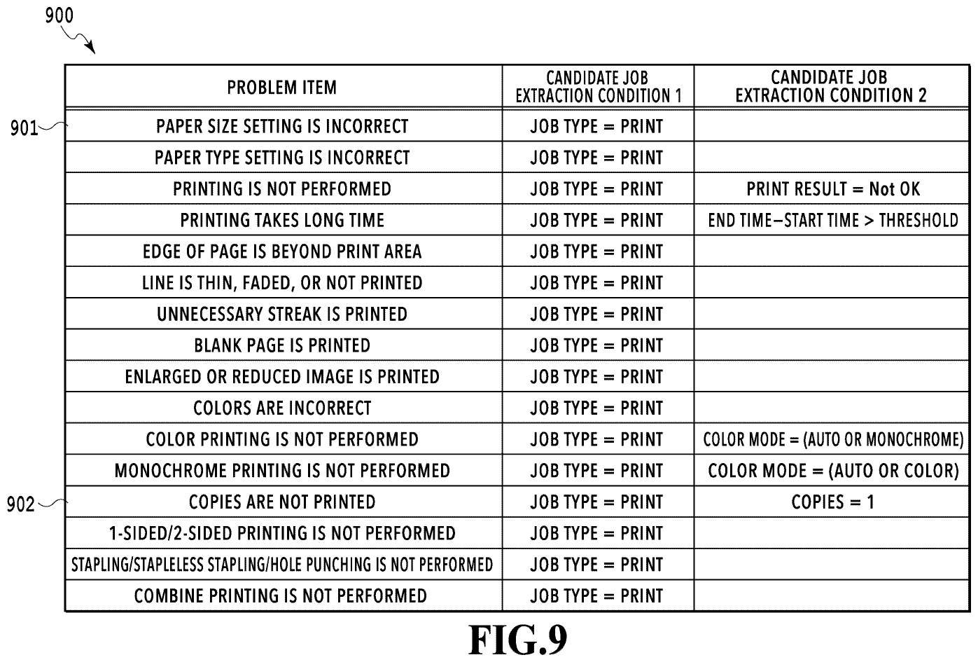

In S801, the problem diagnosing unit 203 obtains a candidate job extraction table 900 (see FIG. 9).

FIG. 9 is a diagram illustrating an example of a candidate job extraction table. In the candidate job extraction table 900 in FIG. 9, a problem item and conditions for extracting candidates for a job in which a problem specified by a problem item occurred (candidate job extraction conditions) are stored in association with each other. The CPU 110 also functions as a management unit to manage the candidate job extraction conditions based on the candidate job extraction table 900.

In S802, from the candidate job extraction table 900 obtained in S801, the problem diagnosing unit 203 obtains the candidate job extraction conditions associated with the problem item selected from the problem item display area 600 in FIG. 6.

For example, the user depresses the menu button 601 in the problem item display area 600 in FIG. 6 displayed in S601, thereby selecting the problem item of “paper size setting is incorrect” in the print function. In this case, in S802, the problem diagnosing unit 203 obtains candidate job extraction conditions from a row 901 in which “paper size setting is incorrect” is held in the problem item in the candidate job extraction table 900. Specifically, “JOB TYPE=PRINT” is obtained as the candidate job extraction condition from a candidate job extraction condition 1 in the row 901. “JOB TYPE=PRINT” means to extract a job in which the value of the job type matches “PRINT”.

In S803, the problem diagnosing unit 203 determines whether or not there is a job log in the job log DB 400 in FIG. 4.

If determining that there is at least one job log in the job log DB 400 in FIG. 4 (YES in S803), the problem diagnosing unit 203 advances the processing to S804. If determining that there is no job log in the job log DB 400 (NO in S803), the problem diagnosing unit 203 ends the flowchart in FIG. 8 because there is no candidate job to be displayed.

The next processes in S804 to S807 constitute loop processing for processing each of process target job logs by iterating a selection of a process target job log from the job logs contained in the job log DB 400. In S804, the problem diagnosing unit 203 selects a process target job log from unprocessed job logs among the job logs contained in the job log DB 400. Then, the processes in S805 and S806 are performed on the process target job log. After completing the processes on the process target job log, a process target job log is again selected from the unprocessed job logs. In a case where there is no more unprocessed job log, the loop processing is terminated and the processing proceeds to S808.

In S805, the problem diagnosing unit 203 determines whether or not the current process target job log matches all the candidate job extraction conditions obtained in S802.

If determining that the current process target job log matches all the candidate job extraction conditions (YES in S805), the problem diagnosing unit 203 advances the processing to S806.

In S806, the problem diagnosing unit 203 adds the process target job log matching all the candidate job extraction conditions as a candidate job. After the process in S806 is completed, the processing proceeds to S807.

For example, suppose that a selected problem item is “paper size setting is incorrect”. In this case, as presented in the row 901 of the candidate job extraction table 900 in FIG. 9, the candidate job extraction condition for “paper size setting is incorrect” is a job in which the value of the job type matches “PRINT”. The job log 401 with the job ID “10000001” contained in the job log DB 400 matches this extraction condition, and therefore the job specified by the job log 401 is extracted as a candidate job. The candidate job is a candidate for a job considered to have the problem specified by the selected problem item.

Although the candidate job extraction method for the case where the selected problem item is “paper size setting is incorrect” is exemplified above, the same candidate job extraction method can be applied to a case where any other problem item is selected. For example, suppose that a problem item of “copies are not printed” is selected. In this case, performed is the processing of extracting, from the job log DB 400, all job logs matching the candidate job extraction conditions that the value of “JOB TYPE” is “PRINT” and the value of “COPIES” is “1” held in a row 902 in the candidate job extraction table 900.

On the other hand, if determining that the process target job log does not match the candidate job extraction conditions (NO in S805), the problem diagnosing unit 203 skips S806 and advances the processing to S807.

In S807, the problem diagnosing unit 203 determines whether or not there is a job log yet to be selected as a process target in the job log DB 400. If determining that there is a job log yet to be selected as a process target (YES in S807), the problem diagnosing unit 203 returns to S804, selects a new job log as a process target, and iterates the processes in S805 and S806.

If determining that all the job logs contained in the job log DB 400 are already selected as the process targets (NO in S807), the problem diagnosing unit 203 advances the processing to S808.

In S808, the problem diagnosing unit 203 determines whether or not there is a candidate job matching the candidate job extraction conditions. If determining that there is a candidate job (YES in S808), the problem diagnosing unit 203 advances the processing to S809. On the other hand, if determining that no candidate job is extracted (NO in S808), the problem diagnosing unit 203 skips S809 and ends the processing in the flowchart of FIG. 8.

In S809, the problem diagnosing unit 203 displays the problem candidate job list 700 in FIG. 7, which is a list of the extracted candidate jobs, on the touch panel display of the operation unit 115.

Regarding the extraction of candidate jobs, described above is the candidate job extraction method using the conditions associated with the problem item according to the candidate job extraction table 900 in FIG. 9. In addition, another condition not associated with the problem item may be further combined for the candidate job extraction. For example, the candidate job extraction may be performed with a condition of 50 latest jobs or a condition of jobs of the log-in user added to the conditions associated with the problem item. The conditions associated with the problem are not limited to the above example.

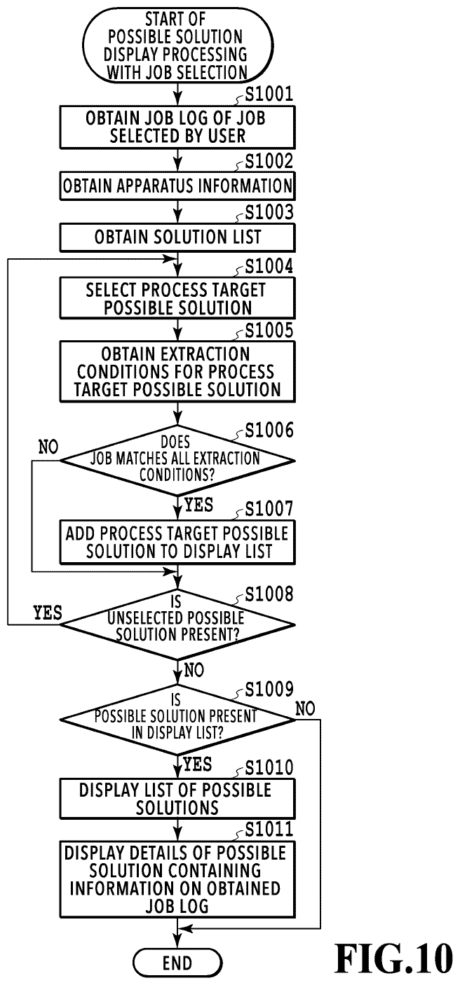

FIG. 10 is a flowchart for explaining the details of the possible solution display processing in S506 of FIG. 5 performed in the case where a job is selected. In S506, performed is the processing of narrowing down possible solutions to the problem based on the problem item selected by the user and the job log of the job selected by the user from among the candidate jobs.

In S1001, the problem diagnosing unit 203 obtains the job log associated with the job selected by the user from the job information display regions 701 to 706 constituting the problem candidate job list 700 in FIG. 7. That is, the problem diagnosing unit 203 obtains the log of the job selected by the user from among the jobs extracted in the processing in the flowchart of FIG. 8.

In S1002, the problem diagnosing unit 203 obtains apparatus information of the image forming apparatus 100. The apparatus information is (current) apparatus information at the time of problem diagnosis, and contains, for example, the paper sizes, the paper types, and the like actually set in the paper feeder cassettes in the image forming apparatus 100.

In S1003, the problem diagnosing unit 203 obtains a solution list.

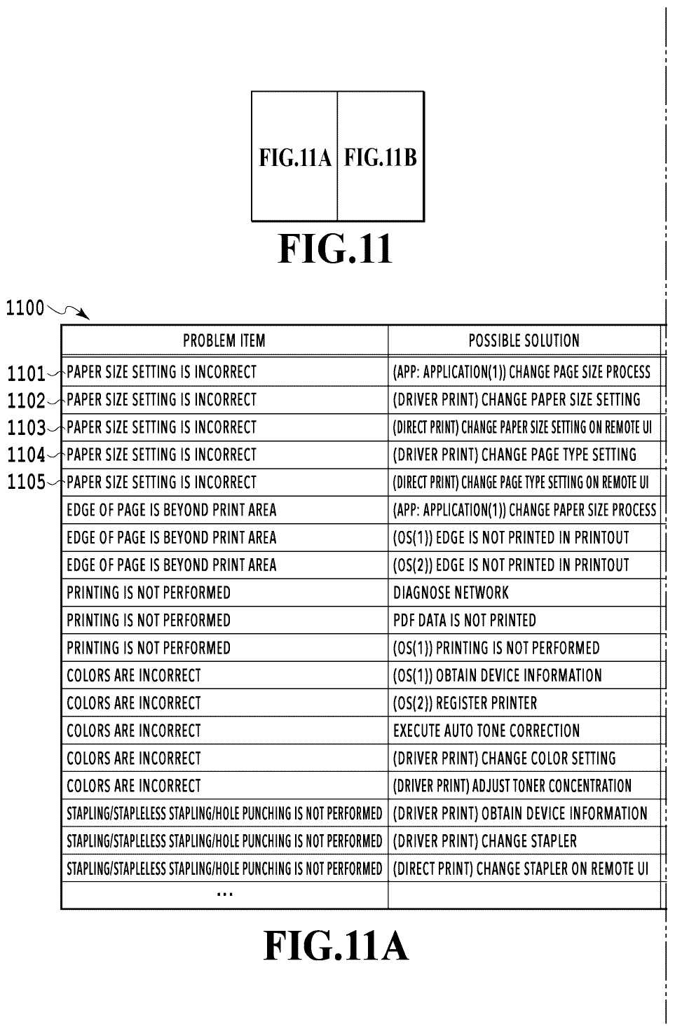

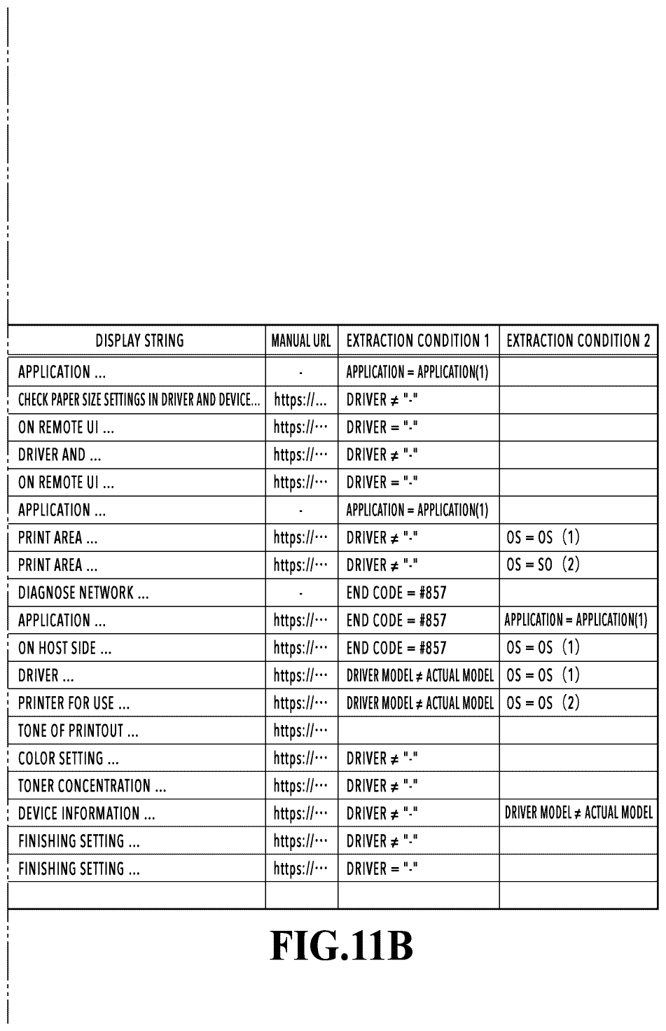

FIGS. 11A and 11B are diagrams presenting an example of a solution list 1100. In the solution list 1100, each of the problem items is associated with one or more possible solutions for resolving the problem. Moreover, in the solution list 1100, extraction conditions are stored in association with each of the possible solutions. The CPU 110 also functions as a management unit to manage the possible solutions based on the solution list 1100.

The following processes in S1004 to S1008 constitute loop processing of iterating the processes on a process target possible solution by changing a selected process target possible solution from one to another.

In S1004, in the solution list 1100, the problem diagnosing unit 203 selects a process target possible solution from the possible solutions associated with the problem item selected by the user from the problem item display area 600 in FIG. 6. For example, in the case where the problem item of “paper size setting is incorrect” is selected, a process target possible solution is selected from possible solutions held in rows 1101 to 1103 in a “possible solution” column of the solution list 1100. Then, the processes in S1005 to S1007 are performed on the selected process target possible solution. After the processes on the process target possible solution are completed, a process target possible solution is again selected from the unprocessed possible solutions among the possible solutions associated with the problem item. In the case where there is no more unprocessed possible solution, the loop processing is terminated and the processing proceeds to S1009.

In S1005, the problem diagnosing unit 203 obtains, from the solution list 1100, the extraction conditions associated with the current process target possible solution. For example, in a case where the process target possible solution is “(Driver Print) Change Paper Size Setting” in the row 1102 in the solution list 1100, “DRIVER #-” held in an extraction condition 1 in the same row 1102 is obtained.

In S1006, the problem diagnosing unit 203 determines whether or not the job log obtained in S1001 for the job selected by the user matches all the extraction conditions of the process target possible solution obtained in S1005.

If determining that the job log matches all the extraction conditions (YES in S1006), the problem diagnosing unit 203 advances the processing to S1007.

In S1007, the problem diagnosing unit 203 adds the process target possible solution to a display list. After the process in S1007 is completed, the processing proceeds to S1008.

On the other hand, if determining that the job log does not match all the extraction conditions (NO in S1006), the problem diagnosing unit 203 skips S1007 and advances the processing to S1008. In this case, the process target possible solution will not be presented to the user.

In S1008, the problem diagnosing unit 203 determines whether or not there is a possible solution yet to be selected as a process target among the possible solutions associated with the problem item in the solution list 1100. If determining that there is a possible solution yet to be selected as a process target (YES in S1008), the problem diagnosing unit 203 returns to S1004, selects an unselected possible solution as a process target, and iterates the processes in S1004 to S1007.

If determining that all the possible solutions associated with the problem item selected by the user are already selected as the process targets (NO in S1008), the problem diagnosing unit 203 advances the processing to S1009.

For example, suppose that the user selects the problem item of “paper size setting is incorrect” from the problem item display area 600 in FIG. 6 displayed in S501 and the job log of the job selected by the user from the problem candidate job list 700 displayed in S504 is the job log 401 with the job ID “10000001” in FIG. 4. In this case, the job log 401 in FIG. 4 is obtained in S1001. In S1004 to S1007, the extraction conditions for each of the possible solutions to the problem item of “paper size setting is incorrect” are compared with the job log 401 obtained in S1001.

For example, suppose that the possible solution “(APP: Application (1)) Change Page Size Process” in the row 1101 in the solution list 1100 is selected as the process target possible solution in S1004. In this case, in S1005, “Application=Application(1)” held in the row 1101 in an extraction condition 1 column in FIGS. 11A and 11B is obtained as the extraction condition for the process target possible solution. In reference to FIG. 4, the value of “Application” in the job log 401 is “-”. For this reason, in S1006, it is determined that the job log 401 does not match the extraction condition for the possible solution “(APP: Application(1)) Change Page Size Process”. Therefore, S1007 is skipped and the possible solution in the row 1101 is not added to the display list.

In FIGS. 11A and 11B, the extraction condition for the possible solution “(Driver Print) Change Paper Size Setting” in the next row 1102 in the solution list 1100 is “DRIVER≠-” held in the extraction condition 1 column. In reference to FIG. 4, the value of the item “Driver” in the job log 401 is “Driver(1)”. For this reason, in S1006 in which “(Driver Print) Change Paper Size Setting” is selected as the process target, it is determined that the job log 401 matches the extraction condition 1. Therefore, the possible solution “(Driver Print) Change Paper Size Setting” held in the row 1102 is added to the display list.

In FIGS. 11A and 11B, the extraction condition for the possible solution “(Direct Print) Change Paper Size Setting on Remote UI” in the next row 1103 in the solution list 1100 is “DRIVER=‘-’” held in the extraction condition 1 column. In reference to FIG. 4, the value of the item “Driver” in the job log 401 is “Driver(1)”. For this reason, in S1006 in which “(Direct Print) Change Paper Size Setting on Remote UI” is selected as the process target, it is determined that the job log 401 does not match the extraction condition. Therefore, the possible solution in the row 1103 is not added to the display list.

As a result of iterating the loop processing in S1004 to S1008, the possible solution “(Driver Print) Change Paper Size Setting” held in the row 1102 in the solution list 1100 in FIGS. 11A and 11B is added to the display list.

In S1009, the problem diagnosing unit 203 determines whether or not there is a possible solution in the display list. If determining that there is a possible solution (YES in S1009), the problem diagnosing unit 203 advances to S1010.

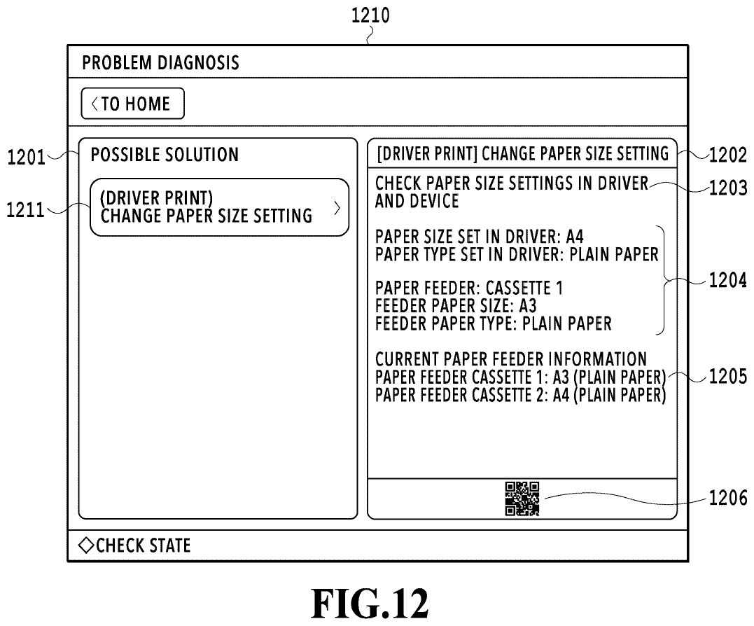

In S1010, the problem diagnosing unit 203 displays a possible solution display screen 1210 (see FIG. 12) containing the determined possible solution on the touch panel display of the operation unit 115.

FIG. 12 is a diagram illustrating an example of a possible solution display screen displayed as a result of the process in S1010. The possible solution display screen 1210 contains a possible solution display region 1201 and a solution details display region 1202.

In the possible solution display region 1201, a button associated with each possible solution contained in the display list is displayed. FIG. 12 presents an example of a screen in the case where the display list contains only the possible solution held in the row 1102 in FIGS. 11A and 11B. For this reason, a button 1211 included in the possible solution display region 1201 is a button on which the text of “(Driver Print) Change Paper Size Setting” specifying the possible solution contained in the display list is displayed.

In S1011, the problem diagnosing unit 203 detects a depression of the button associated with the possible solution contained in the possible solution display region 1201 on the possible solution display screen 1210. The problem diagnosing unit 203 displays the detailed information on the possible solution associated with the detected button in the solution details display region 1202 on the possible solution display screen 1210. The solution details display region 1202 includes subregions 1203 to 1206.

The subregion 1203 displays a text specifying what is the possible solution associated with the button selected by the user from the possible solution display region 1201. FIG. 12 is the diagram in the case where the button 1211 associated with “(Driver Print) Change Paper Size Setting” is depressed. Thus, the subregion 1203 in FIG. 12 displays the text “Driver and Device . . . ” held in a “display string” column in the row 1102 holding the information on “(Driver Print) Change Paper Size Setting” in the solution list 1100 in FIGS. 11A and 11B.

The subregion 1204 is a region for displaying information on the job log obtained in S1001 for the job selected by the user. In FIG. 12, the values of the respective items of “paper size”, “paper type”, “paper feeder”, “feeder paper size”, and “feeder paper type” in the job log 401 are displayed.

The subregion 1205 is a region for displaying the apparatus information obtained in S1002. In FIG. 12, the current paper feeder information, namely, the information on the feeder paper sizes and the feeder paper types of “paper feeder cassette 1” and “paper feeder cassette 2” is displayed as the apparatus information.

The subregion 1206 is a region for displaying information for accessing a manual related to the possible solution associated with the button selected by the user from the possible solution display region 1201. In FIG. 12, an image is displayed which is a two-dimensional code converted from the URL for accessing the manual held in a “manual URL” column in the row 1102 holding the information on “(Driver Print) Change Paper Size Setting” in the solution list 1100. As a result of reading the two-dimensional code, the user can correct the settings of the main unit of the image forming apparatus 100 while checking the solution via a mobile terminal or the like.

In the solution list 1100 of FIGS. 11A and 11B, each possible solution (each row) may be further associated with items of a job log to be displayed in the subregion 1204. Then, the values of the items of the job log associated with the possible solution selected by the user from the possible solution display region 1201 may be displayed in the subregion 1204 of the solution details display region 1202. For example, suppose that the row 1102 in FIGS. 11A and 11B is associated with “paper size”, “paper type”, “paper feeder”, “feeder paper size”, and “feeder paper type” as the items of the job log. In this case, the set values of the respective items of “paper size”, “paper type”, “paper feeder”, “feeder paper size”, and “feeder paper type” contained in the job log 401 are obtained and displayed in the subregion 1204 of the solution details display region 1202. Similarly, regarding the apparatus information displayed in the subregion 1205, each possible solution (each row) in the solution list 1100 may be further associated with items of the apparatus information to be displayed on the subregion 1205.

The user can easily check a difference between the information at the time of job execution displayed in the subregion 1204 and the current apparatus information of the image forming apparatus 100 displayed in the subregion 1205 in the solution details display region 1202 in FIG. 12 by comparing them. The information displayed in the solution details display region 1202 presented in FIG. 12 is just an example, and the information to be displayed is not limited to this example.

The method of determining possible solutions to be displayed on the possible solution display screen 1210 in FIG. 12 is described above by using, as an example, the case where the problem item of “paper size setting is incorrect” is selected and the job log 401 is obtained. The same method of determining possible solutions to be displayed on the possible solution display screen 1210 is also applied to a case where any other problem is selected and any other job log is selected.

For example, suppose that the user selects “paper type setting is incorrect” as a problem item and selects a job in the job information display region 701 from the problem candidate job list 700, so that the job log 401 is obtained. The rows 1104 and 1105 in the solution list 1100 hold information on possible solutions associated with the problem item of “paper type setting is incorrect”. Therefore, the job log 401 is compared with the extraction conditions in each of the rows 1104 and 1105 in the solution list 1100, so that the possible solution to be included in the display list is determined. As a result, in the case where the possible solution held in the row 1104 in the solution list 1100 is added to the display list, the information specifying the possible solution is displayed. In this way, in the case where the user selects the problem item of “paper type setting is incorrect”, only the possible solution related to the job selected by the user from the possible solutions associated with “paper type setting is incorrect” is displayed.

As illustrated in FIG. 12, in the case where the display list contains only one possible solution, the details of the possible solution may be displayed from the beginning. Instead, the details of one of the possible solutions contained in the display list may be displayed in advance on the solution details display region 1202.

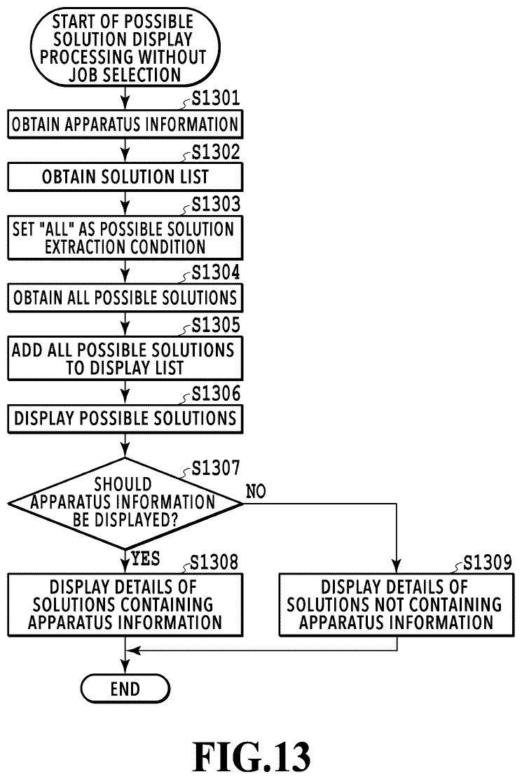

FIG. 13 is a flowchart for explaining the details of the possible solution display processing in S508 of FIG. 5 executed in the case where no job is selected. If the NO JOB button 712 on the problem candidate job display screen 710 in FIG. 7 displayed as a result of S504 in FIG. 5 is depressed, the determination result in S507 is YES and the processing proceeds to S508. In other words, the flowchart in FIG. 13 is started in response to an action of depressing the NO JOB button 712.

There may be a case where a job that the user desires to diagnose does not exist in the problem candidate job list 700 contained on the problem candidate job display screen 710 displayed as a result of S504 in FIG. 5. For example, the problem candidate job list 700 in FIG. 7 presents, as an example, the list of the candidates for the job considered to have the problem of “paper size setting is incorrect” in the “PRINT” function. However, there is a case where a job that the user desires to check does not exist in the problem candidate job list 700. In this case, the user depresses the NO JOB button 712 on the problem candidate job display screen 710 in FIG. 7. The NO JOB button 712 does not have to be displayed depending on a type of a problem.

A process in S1301 is the same as in S1002, in which the problem diagnosing unit 203 obtains the (current) apparatus information of the image forming apparatus 100 at the time of problem diagnosis.

A process in S1302 is the same as in S1003, in which the problem diagnosing unit 203 obtains the solution list 1100 in FIGS. 11A and 11B.

In S1303, the problem diagnosing unit 203 sets “all” as the extraction conditions for extracting all possible solutions.

In S1304, in the solution list 1100, the problem diagnosing unit 203 obtains all the possible solutions associated with the problem item selected by the user from the problem item display area 600 in FIG. 6.

In S1305, the problem diagnosing unit 203 adds the possible solutions obtained in S1304 to the display list.

In S1306, the problem diagnosing unit 203 displays the possible solutions contained in the display list on the touch panel display of the operation unit 115.

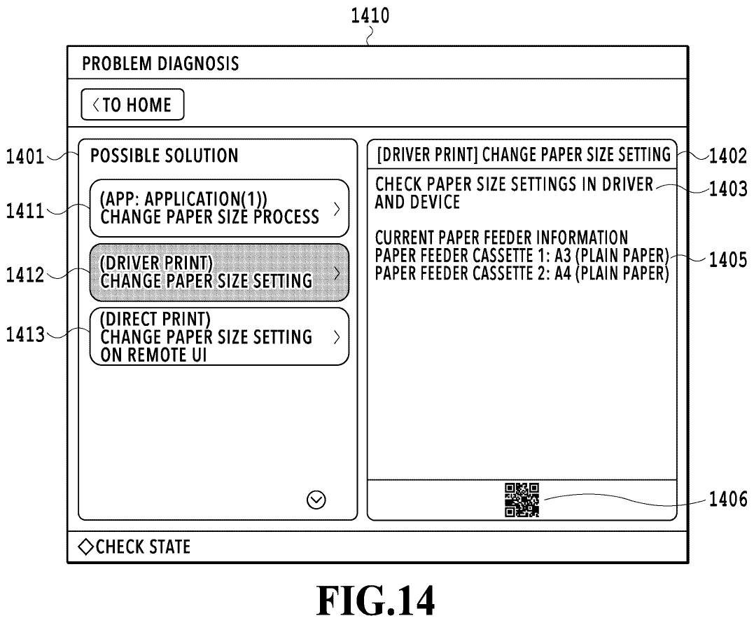

FIG. 14 is a diagram illustrating an example of a possible solution display screen displayed in the case where no job is selected by the user. In FIG. 14, as a result of S1306, buttons 1411 to 1413 respectively associated with the possible solutions contained in the display list are displayed in a possible solution display region 1401 on a possible solution display screen 1410. In other words, the possible solution display region 1401 displays the buttons respectively associated with all the possible solutions associated with the problem item selected by the user. FIG. 14 illustrates the possible solution display region 1401 in the case where the problem item selected by the user is “paper size setting is incorrect” and the user depresses the NO JOB button 712. Thus, the buttons associated with the possible solutions in the rows 1101 to 1103 holding the information on “paper size setting is incorrect” in the solution list 1100 in FIGS. 11A and 11B are displayed.

In a case where all the buttons associated with all the possible solutions contained in the display list cannot be displayed simultaneously on the screen in the possible solution display region 1401, only some of the buttons may be displayed. In this case, the possible solution display region 1401 may be provided with a scroll bar and enable the user to check the buttons of the other possible solutions by scrolling. Although the scrolling is described as an example of the case where all the possible solutions cannot be displayed simultaneously on the screen, the screen may be configured to display them by switching pages.

In S1307, the problem diagnosing unit 203 detects which button is depressed by the user from among the possible solution buttons 1411 to 1413 contained in the possible solution display region 1401 on the possible solution display screen 1410. Then, the problem diagnosing unit 203 determines whether or not to display the apparatus information of the image forming apparatus 100 in a solution details display region 1402 on the possible solution display screen 1410. For example, in a case of diagnosis of a problem item in which the paper size information or the like stored in the image forming apparatus 100 needs to be displayed, the problem diagnosing unit 203 determines to display the apparatus information. If determining to display the apparatus information (YES in S1307), the problem diagnosing unit 203 advances the processing to S1308.

In S1308, the problem diagnosing unit 203 displays details of the possible solution associated with the detected button, the details containing the apparatus information, in the solution details display region 1402 on the possible solution display screen 1410.

In FIG. 14, a button 1412 in the possible solution display region 1401 is a button associated with the possible solution of “(Driver Print) Change Paper Size Setting”. If the user depresses this button 1412, the problem diagnosing unit 203 determines to display the apparatus information in S1307. Therefore, in S1308, the problem diagnosing unit 203 displays the solution details display region 1402 including a subregion 1405 for displaying information on “paper feeder cassette 1” and information on “paper feeder cassette 2” of “current paper feeder information” that is the apparatus information obtained in S1301.

A subregion 1403 is a region for displaying the text held in the display string column in the row 1102 in FIGS. 11A and 11B holding the information on “(Driver Print) Change Paper Size Setting”.

A subregion 1406 is a region for displaying an image of a two-dimensional code converted from the URL held in the row 1102 in FIGS. 11A and 11B.

Here, the solution details display region 1202 in FIG. 12 displayed as a result of execution of S506 is compared with the solution details display region 1402 in FIG. 14. The solution details display region 1402 in FIG. 4 does not include a subregion equivalent to the subregion 1204 in FIG. 12. This is because the information on the job log such as the paper size is not obtained in the flowchart in FIG. 13.

The user is allowed to revise the settings for submitting a job by referring to the paper sizes and the paper types of “paper feeder cassette 1” and “paper feeder cassette 2”, which are the apparatus information of the image forming apparatus 100 displayed in the subregion 1405 in FIG. 14. The above is just an example of the information to be displayed, and the information to be displayed is not limited to the above example.

Whether or not to display the apparatus information is determined based on the problem item selected from the problem item display area 600 in FIG. 6. For example, each problem item is associated with a flag specifying whether or not to display the apparatus information. Then, the problem diagnosing unit 203 obtains the flag associated with the problem item selected by the user and makes the determination in S1307 based on a value of the obtained flag. In the case where the value of the flag is a value indicating an instruction to display the apparatus information, an item of the apparatus information to be displayed may be additionally associated. In the case where the apparatus information is to be displayed, the problem diagnosing unit 203 may obtain the value of the item of the apparatus information to be displayed and display the item and the obtained value in S1308.

For example, the problem items of “paper size” and “paper type” are associated with the flag indicating the instruction to display the apparatus information. Then, the information on the paper sizes and paper types set in the main unit of the image forming apparatus 100 is set to be displayed.

On the other hand, if determining not to display the apparatus information (NO in S1307), the problem diagnosing unit 203 advances the processing to S1309.

In a problem diagnosis for a problem item of “printing takes long time” or the like, there is no need to display the apparatus information of the image forming apparatus 100 because the apparatus information is irrelevant to this type of a problem. In this case, the problem diagnosing unit 203 determines not to display the apparatus information. Moreover, for a problem item of “copies are not printed”, which is a problem related to the driver settings, the problem diagnosing unit 203 determines not to display the apparatus information.

In S1309, the problem diagnosing unit 203 displays the details of the possible solutions without containing the apparatus information. For example, only the display string obtained from FIGS. 11A and 11B and the image of the two-dimensional code converted from the manual URL obtained from FIGS. 11A and 11B are displayed. The above is just an example of the information to be displayed, and the information to be displayed is not limited to the above example.

Also in S1011 of FIG. 10, the determination and processes as in S1307 to 1309 may be performed to switch whether or not to display the apparatus information.

According to the present information described above, the user is allowed to check, together with the solution, the setting information stored in the job log of the job selected by the user and the apparatus information. Thus, according to the present embodiment, the user themselves can more easily perform a change of the set values or the like in order to resolve the problem.

### Second Embodiment

In the present embodiment, description will be given of a method in a problem diagnosis in which a difference between the setting information of a job selected by the user and the current apparatus information is figured out, and a correction example is displayed in a solution. The present embodiment will be described mainly about differences from the first embodiment. Unless otherwise specified, the configuration and processes are the same as those in the first embodiment.

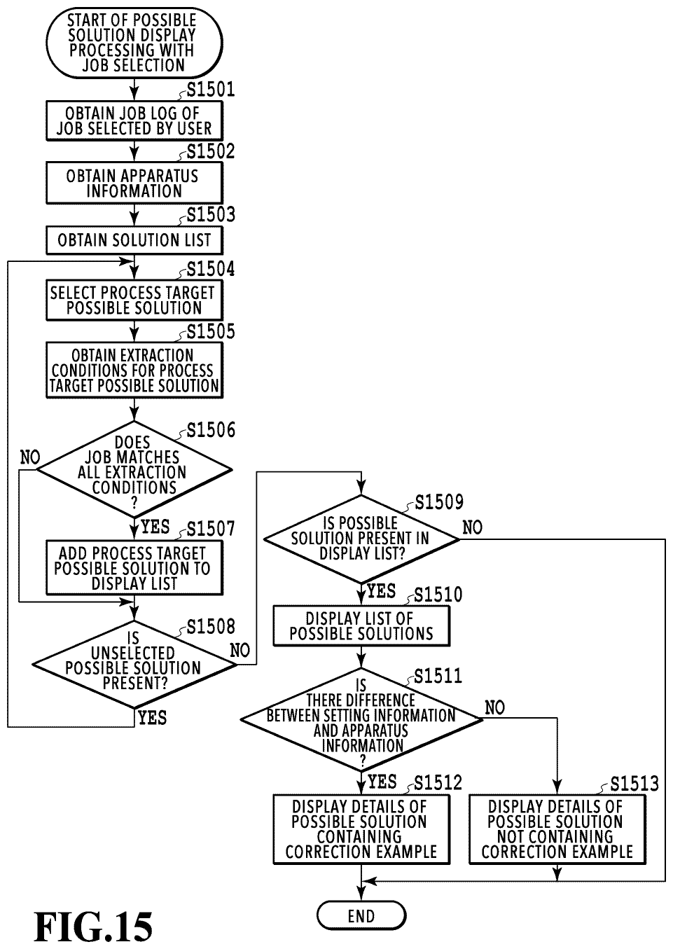

FIG. 15 is a flowchart of possible solution display processing in a case where a job is selected in S506 in FIG. 5 in the present embodiment. In short, FIG. 15 is the flowchart in the present embodiment corresponding to FIG. 10. The processes in S1501 to S1510 in FIG. 15 are the same as those in S1001 to S1010 in FIG. 10, and therefore the description thereof is omitted herein.

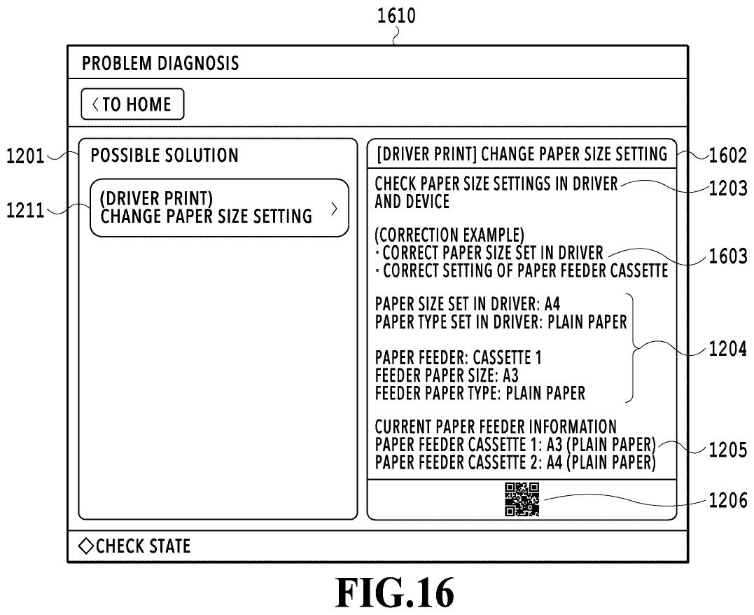

For example, S1510 is a step corresponding to S1010. On the touch panel display of the operation unit 115, the problem diagnosing unit 203 displays a possible solution display screen 1610 (see FIG. 16) containing possible solutions determined as a result of the loop processing in S1504 to S1508.

FIG. 16 is a diagram illustrating an example of the possible solution display screen displayed as a result of the process in S1510. In FIG. 16, the same regions as those in FIG. 12 are denoted by the same numbers. The possible solution display screen 1610 in FIG. 16 includes a possible solution display region 1201 and a solution details display region 1602. The possible solution display region 1201 in FIG. 16 contains a button associated with each of possible solutions contained in the display list as in FIG. 12.

In S1511, the problem diagnosing unit 203 detects that the user depresses the button associated with the possible solution contained in the possible solution display region 1201 in the possible solution display screen 1610. The problem diagnosing unit 203 determines whether or not there is a difference between the information on the items contained in the job log obtained in S1501 for the current problem diagnosis and the apparatus information obtained in S1502. If determining that there is a difference between the information on the items in the job log and the apparatus information (YES in S1511), the problem diagnosing unit 203 advances the processing to S1512.

In S1512, in the solution details display region 1602 in FIG. 16, the problem diagnosing unit 203 displays details of the possible solution containing correction examples for each item having a difference between the job log and the apparatus information of the image forming apparatus, the correction examples each giving an instruction to correct the set value of the item concerned.

Specifically, the problem diagnosing unit 203 displays the text of the display string in the subregion 1203 of the solution details display region 1602 as described in the first embodiment. In addition, the problem diagnosing unit 203 displays the information on the job log in the subregion 1204, the apparatus information in the subregion 1205, and an image of a two-dimensional code converted from the URL for accessing the manual in the subregion 1206. In S1512, the problem diagnosing unit 203 further displays the details of the solution containing correction examples in a subregion 1603 of the solution details display region 1602.

Suppose that the problem item of “paper size setting is incorrect” is selected by the user and the user selects the job associated with the job log 401 from the problem candidate job list 700 in FIG. 7. In addition, suppose that the user depresses the button 1211 of the possible solution of “(Driver Print) Change Paper Size Setting” in the possible solution display region 1201 in FIG. 16.

In this case, the problem diagnosing unit 203 determines whether or not there is a difference between the value of “paper size” set in the driver, which is a portion related to the possible solution among the values of the items contained in the job log 401, and the information on the paper size of the paper feeder cassette in the current apparatus information. If determining that there is a difference, the problem diagnosing unit 203 displays the details of the solution containing the correction examples in the solution details display region 1602. Specifically, the problem diagnosing unit 203 displays the correction examples such as “(Correction Example) Correct Paper Size Set in Driver and Correct Setting of Paper Feeder Cassette” in the subregion 1603 of the solution details display region 1602. The above is just an example of the information to be displayed, and the information to be displayed is not limited to the above example.

If determining that there is no difference between the setting information in the job log and the apparatus information (NO in S1511), the problem diagnosing unit 203 advances the processing to S1513. In S1513, the problem diagnosing unit 203 displays the details of the solution not containing any correction example in the solution details display region 1602. For example, in S1513, the details of the possible solution not containing the subregion 1603 are displayed as in the solution details display region 1202 in FIG. 12.

As described above, according to the present embodiment, correction examples are displayed as details of a solution, so that the user can easily check the settings for resolving the problem by referring to the correction examples.

### Other Embodiments

The processing executed by the controller unit 120 in the image forming apparatus 100 in the foregoing embodiments may be performed by an external apparatus separate from the image forming apparatus 100. For example, an information processing apparatus connected to the image forming apparatus 100 via the network, such as a server not illustrated, may perform at least part of the processing in the flowcharts for the problem diagnoses described in the foregoing embodiments. The functional configuration of the information processing server may be the same as in the controller unit 120 in FIG. 1 and the configuration in FIG. 2.

In Japanese Patent Laid-Open No. 2020-087136, only predetermined sentences are displayed as solutions. For this reason, in the method of Japanese Patent Laid-Open No. 2020-087136, the information displayed may be insufficient to resolve a problem and there is a possibility that a user will not be able to resolve the problem by themselves. According to the technique disclosed herein, it is possible to display information concerning the occurrence of a problem.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-121303, filed Jul. 26, 2024, which is hereby incorporated by reference herein in its entirety.

What is claimed is:

1. An information processing apparatus comprising:
a first obtaining unit configured to obtain information on an item selected by a user from items each specifying a problem tending to occur in execution of a print job;
a second obtaining unit configured to obtain setting information of a print job selected by the user from print jobs which were executed by an image forming apparatus and which were extracted as candidates for a job in which the problem specified by the selected item occurred; and
a display control unit configured to display a screen which contains a solution for the problem based on the information obtained by the first obtaining unit and contains the setting information of the print job obtained by the second obtaining unit.

2. The information processing apparatus according to claim 1, further comprising
an extraction unit configured to extract the print job as the candidate in which the problem specified by the selected item occurred from the print jobs executed by the image forming apparatus, wherein
the second obtaining unit obtains the setting information of the print job selected by the user from the extracted print jobs.

3. The information processing apparatus according to claim 1, wherein
the setting information obtained by the second obtaining unit contains information on PDL data for the print job or setting information of a driver used to create the print job.

4. The information processing apparatus according to claim 1, further comprising
a third obtaining unit configured to obtain setting information of the image forming apparatus, wherein
a display control unit configures to display the screen further containing the setting information of the image forming apparatus.

5. The information processing apparatus according to claim 4, wherein
the display control unit displays either the screen containing the setting information of the image forming apparatus or the screen not containing the setting information of the image forming apparatus depending on the selected item.

6. The information processing apparatus according to claim 1, wherein
the display control unit displays a list of the items each specifying a problem occurred in execution of a print job, and
the selected item is an item selected by the user from the items included in the list.

7. The information processing apparatus according to claim 2, wherein
the extraction unit extracts the print job as the candidate by extracting each print job matching an extraction condition associated with the selected item.

8. The information processing apparatus according to claim 1, further comprising
a first management unit configured to manage a log of a print job executed by the image forming apparatus, wherein
the second obtaining unit obtains the setting information from the log of the print job selected by the user.

9. The information processing apparatus according to claim 1, further comprising
a second management unit configured to manage the information associated with each item specifying a problem, wherein
the first obtaining unit obtains the information associated with the selected item, as the information on the selected item.

10. The information processing apparatus according to claim 9, wherein
the second management unit further manages an extraction condition associated with the solution associated with the item specifying a problem, and
the first obtaining unit obtains, as the information on the selected item, the solution whose extraction condition matches a log of a print job selected by the user from the solution associated with the selected item.

11. The information processing apparatus according to claim 1, wherein
the screen contains a region for displaying a detail of the solution selected by the user from solutions displayed on the screen, and
the display control unit displays the obtained setting information of the print job in the region.

12. The information processing apparatus according to claim 2, wherein
the display control unit displays a list of the extracted print jobs, and
in a case where the user indicates that no print job is to be selected from the list, the display control unit displays the screen so as to display all solutions associated with the selected item.

13. The information processing apparatus according to claim 4, wherein
in a case where a portion having a difference between the setting information of the image forming apparatus and the log of the print job selected by the user is found as a result of comparing them, the display control unit displays the screen containing an example of correction of settings in the portion.

14. The information processing apparatus according to claim 1, wherein
the information processing apparatus is included in the image forming apparatus, and
the display control unit performs control to display the screen on a display unit of the image forming apparatus.

15. An information processing method for processing information related to one or more jobs executed by an image forming apparatus, the method comprising:
obtaining information on an item selected by a user from items each specifying a problem tending to occur in execution of a print job;
obtaining setting information of a print job selected by the user from print jobs which were executed by the image forming apparatus and which were extracted as candidates for a job in which the problem specified by the selected item occurred; and
displaying a screen which contains a solution for the problem based on the information obtained by the first obtaining unit and contains the setting information of the print job obtained by the second obtaining unit.
